(19) United States
(12) Patent Application Publication
(10) Pub. No.: US 2018/0313607 A1
(43) Pub. Date: Nov. 1, 2018

(54) DEVICE AND METHOD FOR THERMALLY TREATING A CONTINUOUS WEB OF TEXTILE MATERIAL

(71) Applicant: TRUETZSCHLER GMBH & CO. KG, Moenchengladbach (DE)

(72) Inventor: Markus BÖHN, Hainburg (DE)

(73) Assignee: TRUETZSCHLER GMBH & CO. KG, Moenchengladbach (DE)

(21) Appl. No.: 15/770,212

(22) PCT Filed: Sep. 9, 2016
(86) PCT No.: PCT/EP2016/071286

§ 371 Date: Apr. 22, 2018

(30) Foreign Application Priority Data
Oct. 30, 2015 (DE) 102015118596.2

(51) Int. Cl. F26B 13/16; F26B 21/12; F26B 3/06

(52) U.S. Cl. CPC F26B 13/16; F26B 3/06; F26B 21/12

(57) ABSTRACT

A device and a method for thermally treating a continuous web of textile material, including at least one through-flow drum having a perforated envelope surface, a continuous web of material looping at least partially around the envelope thereof, wherein a heated gas flows through the continuous web of material and the envelope of the through-flow drum. An air-guiding cylinder having a plurality of openings is disposed within the through-flow drum, the heated gas being withdrawn via the interior compartment thereof, wherein the air or gas permeability of the air-guiding cylinder is adjustable.

### CROSS-REFERENCE TO RELATED APPLICATIONS

This application is a U.S. National Stage of International Patent Application No. PCT/EP2016/071286 filed Sep. 9, 2016, designating the United States and claiming benefit of German Patent Application No. 10 2015 118 596.2 filed Oct. 30, 2015.

### BACKGROUND OF THE INVENTION

The invention relates to a device for thermally treating a continuous web of textile material, in particular a drum dryer or thermobonder, including at least one through-flow drum having a perforated envelope surface and adapted for having a continuous web of material looped at least partially around the envelope surface, wherein a heated gas is flowable through the continuous web of material and the envelope surface of the through-flow drum, as well as a to method for thermally treating a continuous web of textile material in a drum dryer or a thermobonder including at least one through-flow drum having a perforated envelope, with a continuous web of material looping at least partially around the envelope, including flowing a heated gas through the continuous web of material and the envelope of the through-flow drum.

Thermal treatment methods for a continuous web of textile material from webs or nonwovens include the hot air drying or hot air tangling in a through-flow dryer, in which heated gas, for example air, flows through the continuous web of material and thereby dries or tangles it. Dryers for drying or tangling continuous webs of textile material are known, in which one or several drums are disposed in a housing. A continuous web of textile material is fed to the dryer via an opening in the dryer chamber, in that the web loops around the drum to a large extent of the circumference, and is then guided around the next drum and/or guided out of the dryer chamber. Usually, also the fresh air, which is heated within the dryer chamber and mixed with the ambient air, is supplied via said opening, so as to absorb the highest possible percentage of humidity. When looping around the drum, the mixture of ambient air and fresh air flows through the continuous web of material, at least partially absorbs the humidity of the continuous web of material and is discharged via the interior compartment of the drum.

Based on the air supply, for example via the opening in the dryer chamber, which extends across the entire working width, and the air discharge, which is realized at a frontal face of the dryer, irregular flow conditions result within the dryer, whereby the air flows at different rates, with different amounts, and different qualities through the continuous web of material. Therefore, the continuous web of material may present a different level of quality across the width thereof, which is not desired. Furthermore, the energy conditions of the dryer (among others, the flow rate) always need to be adapted to the least favourable flow technological situation, whereby the energy consumption is higher than necessary.

The documents U.S. Pat. No. 4,835,880 and U.S. Pat. No. 3,742,734 describe dryers, in which the working width is adjustable symmetrically towards the centre by means of cylinders or covering elements disposed within the drum.

In the documents U.S. Pat. No. 6,378,226 and U.S. Pat. No. 5,185,940, the screen cover, within which the drum is disposed, is configured to be adjustable by means of perforations. Therefore, the harmonization of the flow is realized exclusively outside the drum.

In the document U.S. Pat. No. 6,138,380, the exhaust air is withdrawn segment-wise from the dryer around the circumference thereof. Thereby, reversed flow conditions are created, wherein the continuous web of material is only dried through the part of the drum having open-pores.

### SUMMARY OF THE INVENTION

The object of the invention is to further develop a device and a method for thermally treating a continuous web of textile material, in particular in a drum dryer or thermobonder, including at least one through-flow drum having a perforated envelope surface, a continuous web of material looping at least partially around the envelope thereof, wherein heated gas flows through the continuous web of material and the envelope of the through-flow drum.

This object is achieved based on a device for thermally treating a continuous web of textile material as first described above, and additionally including an air-guiding cylinder disposed within the flow drum and having a plurality of openings, wherein the heated gas is withdrawable via an interior compartment thereof, wherein the air-guiding cylinder has an air or gas permeability that is adjustable around a circumference thereof.

The inventive method is solved with the a method for thermally treating a continuous web of textile material as first described above and additionally including: disposing an air-guiding cylinder within the through-flow drum; withdrawing the heated gas via an interior compartment of the air-guiding cylinder, wherein a flow compartment is disposed between the air-guiding cylinder and the through-flow drum; and modifying the flow conditions of the heated gas by adjusting the air or gas permeability of the air-guiding cylinder.

The invention includes the technical teaching that an air-guiding cylinder having a plurality of openings is disposed within the through-flow drum, the heated gas being withdrawn via the interior compartment thereof, wherein the air or gas permeability of the air-guiding cylinder is adjustable.

It is via the adjustable air or gas permeability of the air-guiding cylinder that the air flow within the flow compartment may be influenced, which in turn has an influence on the uniformity of the through-flow through the continuous web of material.

According to an advantageous exemplary embodiment, the air or gas permeability of the air-guiding cylinder is adjustable along the longitudinal axis thereof. Thereby, the irregular air flow, which flows-in along the entire longitudinal axis through the intake area and is withdrawn at a frontal face at the suction device, may be harmonized in the flow compartment.

In this case, the air or gas permeability of the air-guiding cylinder is adjustable around the circumference thereof. The adjustability around the circumference allows for compensating for flow differences, which for example are created by a modification of pressure losses in the material as a result of the process. As an alternative, general flow irregularities may be compensated for and corrected around the circumference.

Advantageously, at least one cover body is disposed at or within the air-guiding cylinder, by means of which the openings of the air-guiding cylinder may be closed, at least partially. Thereby, the air or gas permeability of the air-guiding cylinder may be adjusted along the longitudinal axis thereof or around the circumference thereof.

It is particularly advantageous that the air-guiding cylinder may be subdivided into sections, wherein the air or gas permeability of each section is separately adjustable. Preferably, the sections are disposed along the longitudinal axis of the air-guiding cylinder. Thereby, the air or gas permeability of the air-guiding cylinder may be for example smaller in a middle area than in the border area.

As the air or gas permeability of each section is adjustable along the longitudinal axis thereof and/or around the circumference thereof, the air flow in the flow compartment may be adjusted in a very targeted manner, whereby heated air or heated gas flows in a uniform manner through the continuous web of material.

The inventive method for thermally treating a continuous web of textile material, including at least one through-flow drum having a perforated envelope, a continuous web of material looping at least partially around the envelope thereof, wherein heated gas flows through the continuous web of material and the envelope of the through-flow drum, is characterized in that an air-guiding cylinder is disposed within the through-flow drum, the heated gas being withdrawn via the interior compartment thereof, wherein a flow compartment is disposed between the air-guiding cylinder and the through-flow drum, the flow conditions being modifiable by means of the adjustability of the air or gas permeability of the air-guiding cylinder around the circumference thereof. The more uniform air flow in the flow compartment optimizes the through-flow through the continuous web of material, whereby the energy expenses of the dryer or thermobonder may be reduced.

### BRIEF DESCRIPTION OF THE DRAWINGS

Further measures enhancing the invention will be illustrated in more detail below in conjunction with the description of one preferred exemplary embodiment of the invention based on the Figures. In the drawings:

FIG. 1 shows a diagrammatic illustration through the cross-section of a dryer;

FIG. 2 shows a partial section through a through-flow drum;

FIG. 3 shows a perspective sectional illustration through a through-flow drum,

FIG. 4 shows an enlarged illustration on a detail of an air-guiding cylinder;

FIG. 5 shows a further enlarged illustration on a detail of an air-guiding cylinder;

FIG. 6 shows a further enlarged illustration on a detail of an air-guiding cylinder.

### DETAILED DESCRIPTION OF THE INVENTION

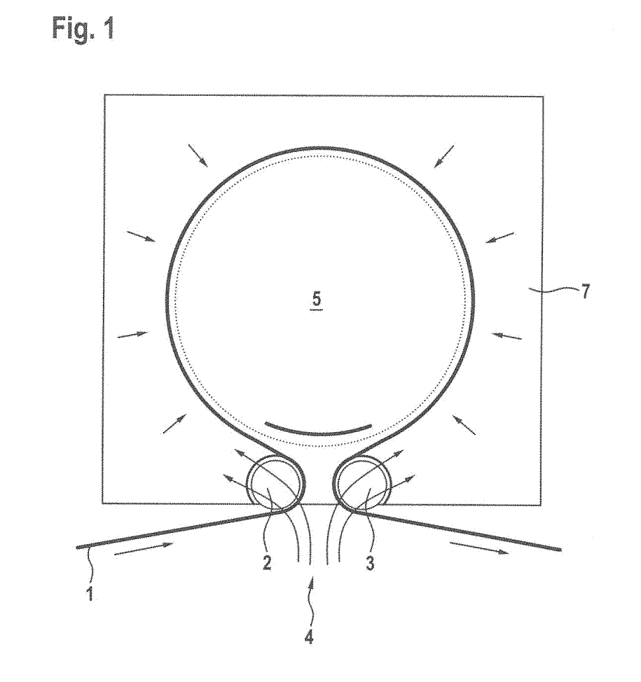

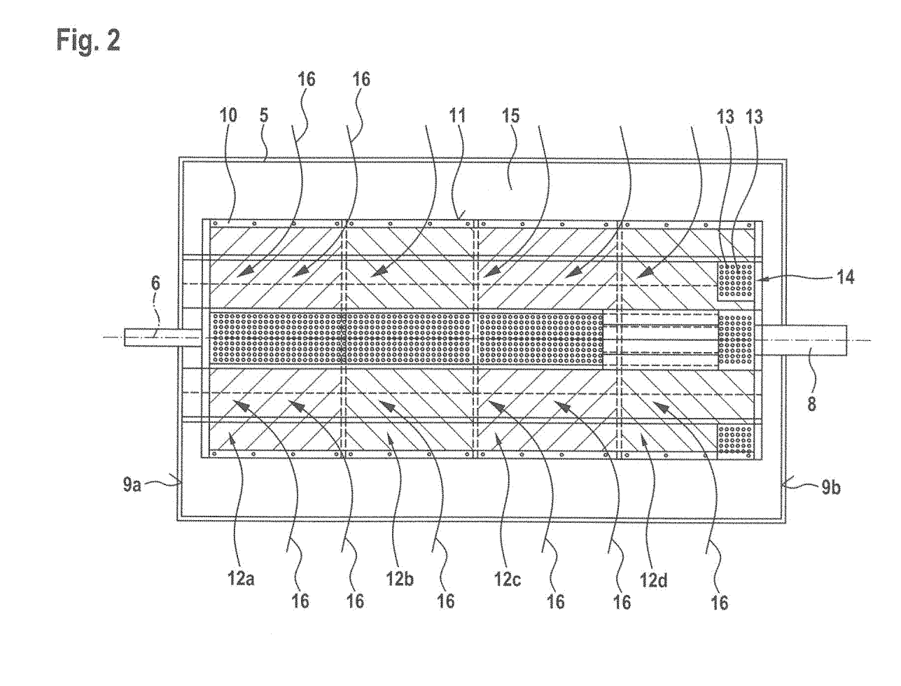

FIG. 1 shows a dryer operated with heated air in an omega construction type according to the state-of-the-art. In the intake area 4, the continuous web of material 1 to be dried enters the dryer via a deflection drum 2, loops clockwise around the air permeable configured through-flow drum 5 and exits the dryer via another deflection drum 3. The through-flow drum 5 as well as the two deflection drums 2, 3 are disposed in a housing 7, into which hot air is introduced via non-illustrated means. The hot air flows through the continuous web of material 1, and dries the latter thereby, and is evacuated by means of a frontal-sided suction disposed at one or the frontal faces of the through-flow drum 5, for example the suction device 8 in FIG. 2, through a non-illustrated ventilator. In this case, vacuum is created in the through-flow drum 5 such as to have different flow conditions within the dryer.

According to FIG. 2 and the invention, an air-guiding cylinder 10, which is at least partially air permeable and cylindrically configured, is disposed within the through-flow drum 5 concentrically with regard to the longitudinal axis 6 of the through-flow drum 5, wherein the air or gas permeability of the air-guiding cylinder 10 is adjustable. In this case, the envelope surface 11, which includes a plurality of openings 13, is configured to be air permeable.

The air-guiding cylinder 10 is configured similarly to a perforated tube and disposed concentrically at a constant distance to the through-flow drum 5. Thereby, a cylindrically circumferential flow compartment 15, in which the air flow 16 is harmonized by means of the adjustable air or gas permeability of the air-guiding cylinder 10, is formed between the through-flow drum 5 and the air-guiding cylinder 10. Essentially, the size, respectively the volume of the flow compartment 15 is formed by means of the differences in diameter of the through-flow drum 5 to the air-guiding cylinder 10. In this case preferably, the diameter of the air-guiding cylinder 10 amounts to between 20 and 80% of the diameter of the through-flow drum 5. The air-guiding cylinder 10 extends likewise along the entire length of the through-flow drum 5 and preferably terminates with the same frontal faces 9a, 9b, as the through-flow drum 5. Thereby, the air-guiding cylinder 10 may likewise extend across the entire working width of the dryer. Based on the vacuum created in the air-guiding cylinder 10 by means of the one or the suction devices, the air flow is harmonized in the flow compartment 15, whereby the air flow 16 through the through-flow drum 5 and thereby through the continuous web of material 1 is uniformly realized in the flow compartment 15 along the longitudinal axis 6.

The air or gas permeability of the air-guiding cylinder 10 is produced by means of a plurality of openings 13 or holes in the envelope surface 11 of the cylindrical tube body of the air-guiding cylinder 10, whereby the magnitude of the permeability of the openings 13 is adjustable, including a complete closure. Preferably, the openings 13 are configured to be round or oval, respectively elliptical, wherein, with oval or elliptical openings 13, the longitudinal axis thereof is oriented preferably parallel or rectangularly to the longitudinal axis 6, in order to achieve a high and precise range of adjustment of the permeability by means of displacing or rotating a cover body. The plurality of openings 13 may be likewise regularly distributed along the entire length and around the entire circumference of the air-guiding cylinder 10. In this exemplary embodiment of FIG. 2, the openings 13 are disposed as far as to the border area 14 of the envelope surface 11, and reach thereby very close to the frontal faces 9a, 9b of the through-flow drum 5.

Adjusting the air or gas permeability may be realized via a cover body in the shape of a second non-illustrated cylinder or by means of individual shells or rounded segments, which is/are disposed at the openings 13 within the air-guiding cylinder 10, for example in an identical number, shape and size. The air or gas permeability is adjustable between 0 and 100% via a very small axial or radial adjusting path of the inside located cylinder or the shells, respectively the rounded segments.

As an alternative, the air-guiding cylinder 10 may be configured as an almost cylindrical polygon having a plurality of flat surfaces along the longitudinal axis 6, the openings 13 thereof being closable by means of various cover bodies in the shape of metal sheets, which are disposed within the air-guiding cylinder 10 and which are displaceable lengthwise or transversely with regard to the longitudinal axis 6 by a predetermined amount. This is advantageous in that the air or gas permeability of the air-guiding cylinder 10 may be irregularly adjusted around the circumference. The adjustability around the circumference allows for compensating flow differences, which for example are created by a modification of pressure losses in the material as a result of the process. In this case, basically flow irregularities around the circumference of the air-guiding cylinder may be corrected.

Thereby, a modifiable air or gas permeability is possible around the circumference of the air-guiding cylinder 10 during operation. Thereby, for example when starting the dryer or thermobonder, the air-guiding cylinder 10 may have the maximum air or gas permeability, and, depending on the width of the continuous web of material or the textile fibres to be processed, during the further operation may reduce the air or gas permeability along the longitudinal axis or around the circumference thereof, in order to modify the air flow 16 in the flow compartment 15.

According to the exemplary embodiment shown in FIG. 2, the air-guiding cylinder 10 may be subdivided into several sectors (12a to 12d) along the longitudinal axis 6 thereof. In this case, each sector (12a; 12b; 12c; 12d) is adjustable in terms of the air or gas permeability thereof evenly around the circumference, but separately along the longitudinal axis 6.

The embodiment according to FIG. 2 shows an air-guiding cylinder 10, which has been subdivided into four sectors (12a; 12b; 12c; 12d). Depending on the length of the air-guiding cylinder 10 the number of sectors may amount from 2 to 10 for example. For a working width of the dryer or thermobonder of 5 m, each of the ten sectors could have a length of 0.5 m, for example. Each sector may be adjusted separately and independently of the other sectors in terms of the air or gas permeability thereof. Thereby, for example the air or gas permeability in the border area of the air-guiding cylinder 10, namely in the area of the frontal faces 9a, 9b, may be increased, in order to increase the air flow in the flow compartment 15 at the edges of the continuous web of material 1. In an alternative adjustability, it may be intended to increase the air or gas permeability of the air-guiding cylinder 10 along the longitudinal axis 6 from the suction device 8 to the frontal face 9a, because the largest pressure difference is found in the area of the suction, and therefore the air flow is very irregular in the flow compartment 15.

In a particular embodiment, the air-guiding cylinder 10, as an air permeable almost cylindrical tube having a plurality of openings 13, may be subdivided around the circumference into four sectors (12a; 12b; 12c; 12d). One cover body in the shape of an interior separate tube for opening or covering the openings 13 may be disposed for each sector (12a; 12b; 12c; 12d). Said interior separate tubes may be displaced along the longitudinal axis 6, or as an alternative, which is structurally easier realized, rotated about the longitudinal axis 6 by an amount slightly larger than one opening 13.

In an alternative embodiment, the air-guiding cylinder 10 may be configured almost as a cylindrical polygon having a plurality of flat surfaces along the longitudinal axis 6, the openings 13 thereof being closable by means of various displaceable metal sheets disposed at or within the air-guiding cylinder 10. The air-guiding cylinder 10 is subdivided into several sections (12a; 12b; 12c; 12d) along the longitudinal axis 6, in this case for example 4 sections, which each are separately adjustable in terms of the air or gas permeability. Each section extends around the entire circumference of the air-guiding cylinder 10, however only over a partial area along the longitudinal axis 6.

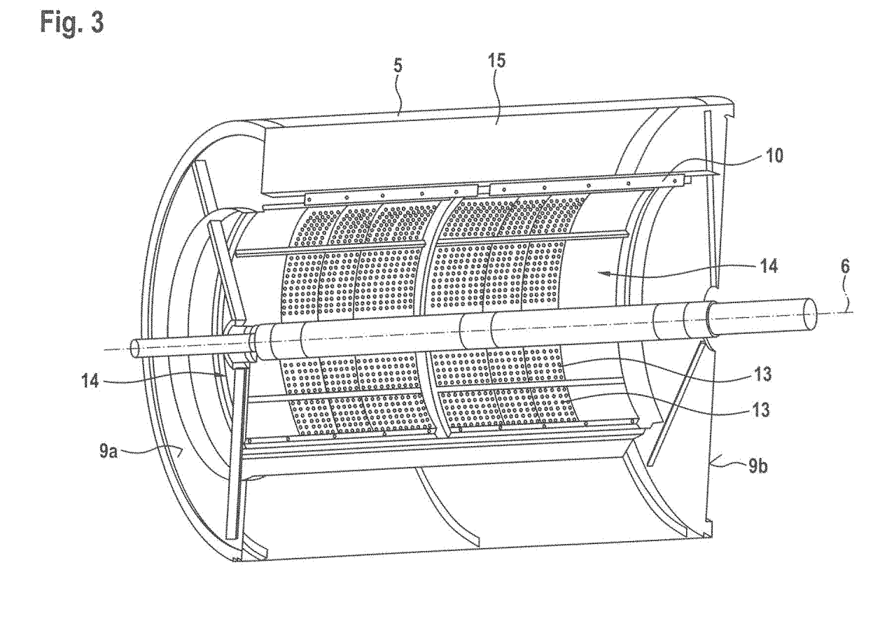

In FIG. 3, the cylindrical through-flow drum 5 is shown in a perspective sectional illustration, the air-guiding cylinder 10 being disposed there within. In this exemplary embodiment, the diameter of the air-guiding cylinder amounts to approximately 60% of the diameter of the through-flow drum 5. The air-guiding cylinder 10 extends along the longitudinal axis 6 as far as to the frontal faces 9a, 9b, wherein the envelope surface 11 on both sides includes respectively one border area 14 without openings 13. This embodiment may be advantageous in that, when the through-flow drum 5 is designed for a continuous web of material 1 of a maximum width, however, simultaneously also smaller continuous webs of material 1 are to be processed, and the through-flow drum 5 may be covered if required in the border areas. The cover bodies, which are intended to close, respectively to cover the openings 13 for affecting the air or gas permeability are not shown in this Figure for better visibility.

Based on the variable disposition of the size and number of openings 13 on the envelope surface 11 of the air-guiding cylinder 10, as well as the diameter ratios of the air-guiding cylinder 10 to the through-flow drum 5, an effective ratio of the perforated surface of the through-flow drum 5 to the effectively punched surface in the air-guiding cylinder 10 of 8 to 20 is achieved, in which the air flow 16 is advantageously harmonized.

The area, in which the respective envelope surface is perforated, respectively punched, is understood as the effective perforated, respectively punched surface. This ratio translates into the dimension of air-guiding cylinder 10 depending on the drum envelope. It likewise translates into the size, respectively the volume of the flow compartment, which is decisive for the effect of the harmonization.

Advantageously, the air flow 16 is also harmonized in that the ratio between the free surface of the envelope of the through-flow drum 5 and the free surface of the air-guiding cylinder is in the range of 2 to 10. The free surface or also the free cross-section is indicated as the relative free surface with holes (air passage) in %.

Based on the high velocity, with which the air flow 16 is suctioned through the openings 13 of the air-guiding cylinder 10 to the ventilator, a pressure change is created within the flow compartment 15, whereby the air flow through the continuous web of material 1 reaches the through-flow drum 5 in a more harmonized manner.

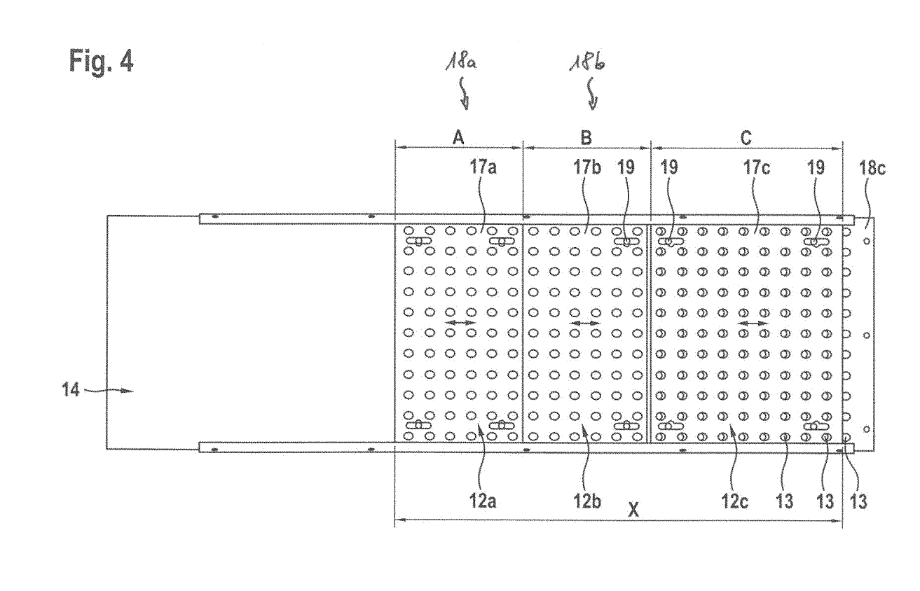

FIG. 4 illustrates a detail of the surface of an air-guiding cylinder 10, which is configured as a polygon having several flat surfaces. The same arrangement is achieved with a cylindrical air-guiding cylinder, which may consist of a rounded metal sheet and in which the openings of sections may be covered by individual shells or rounded segments.

In this case, with an air-guiding cylinder configured as a polygon having several flat surfaces, by way of example one single flat surface is illustrated, which may be also rounded or curved in circumferential direction. A border area 14, which has no openings 13, is disposed in the left area of the illustration. The latter is adjoined by partial areas of an air-guiding cylinder 18a, 18b, and 18c having a plurality of openings 13, which may be covered by means of cover bodies, which are disposed above and in the shape of three flat or rounded metal sheets 17a, 17b, 17c having different widths A, B, C. The cover bodies may be likewise disposed below the partial areas of the air-guiding cylinder.

In this case, each cover body, namely each metal sheet 17a, 17b, 17c is a part of one surrounding section 12a, 12b, 12c. Therefore, each surrounding section 12a, 12b, 12c also has the width A, B or C around the entire circumference. The metal sheets 17a, 17b, 17c may be adjoined by further metal sheets for covering respectively another surrounding section, wherein the last section may end at a border area or directly at a frontal face.

Respectively one partial area of an air-guiding cylinder 18a, 18b, and 18c, from which only the partial area 18c is visible in this illustration, is disposed below the metal sheets 17a, 17b, 17c. Said partial area 18c is likewise configured as a metal sheet and has the same openings 13 as the metal sheet 17c, with which the covering is realized. Preferably, the size and the distance of the openings 13 from the metal sheet 17c and the partial area 18c are the same. The metal sheets 17a, 17b, 17c may be displaced along an arbitrarily disposed guide 19, in order to completely open, completely close, or to close, respectively to open in one partial area the openings 13 of the partial areas 18a, 18b, 18c. Therefore, the displacement path of the metal sheets 17a, 17b, 17c amounts to at least the rough opening width of the opening 13.

Basically, the adjustability of the cover bodies may be realized manually or automatically. In this case for example a non-illustrated arm assembly, lever or spindle system may be disposed in the air-guiding cylinder 10, by means of which the cover bodies are axially or radially displaceable. However, the arm assembly, lever or spindle system may be operated again by means of an electro-motor, hydraulic or pneumatic drive.

The adjustability of the cover bodies may be controllable depending on the operating conditions. For example upon starting, the maximum air or gas permeability of the air-guiding cylinder 10 may be set by completely opening the openings 13. After the flow level in the flow compartment 15 is stabilized, the flow velocity in individual areas of the flow compartment 15 may be influenced by means of a targeted partial or complete closing, respectively covering individual openings over individual sections, which influences on the through-flow through the continuous web of material around the through-flow drum. Advantageously, for this purpose sensors are disposed in the flow compartment, the data thereof being utilized in a data processor for controlling, respectively regulating the air flow. Advantageously, the energy consumption, which among others is composed of supplied heating energy, amount of air or gas and ventilator output, may be reduced via the effect on the air flow 16 in the flow compartment 15.

Corresponding to this exemplary embodiment, the sections 12a, 12b, 12c may have a different width A, B or C along the longitudinal axis of the air-guiding body. The sum of the width, A, B, C along the longitudinal axis of the air-guiding cylinder 10 results in the perforated area having a width X. Said width X depends on the working width of the dryer or the drum diameter.

According to the desired flow conditions depending on the continuous web of material to be dried, each section 12a, 12b, 12c may have a different size and number of openings 13. Based on this illustration, it becomes apparent that also each section 12a, 12b, 12c around its circumference and along the longitudinal axis 6 of the air-guiding cylinder may close the openings 13 differently, with the intention to affect the flow conditions. In this embodiment, each cover body, in this case in the shape of the metal sheets 17a, 17b, 17c is individually controllable, both along the longitudinal axis 6 or in the circumferential direction of the air-guiding cylinder (not illustrated).

For an air-guiding cylinder having a cylindrical tube body, at least in the longitudinal axis 6, the openings 13 of each section 12a, 12b, 12c are separately closable with a cover body.

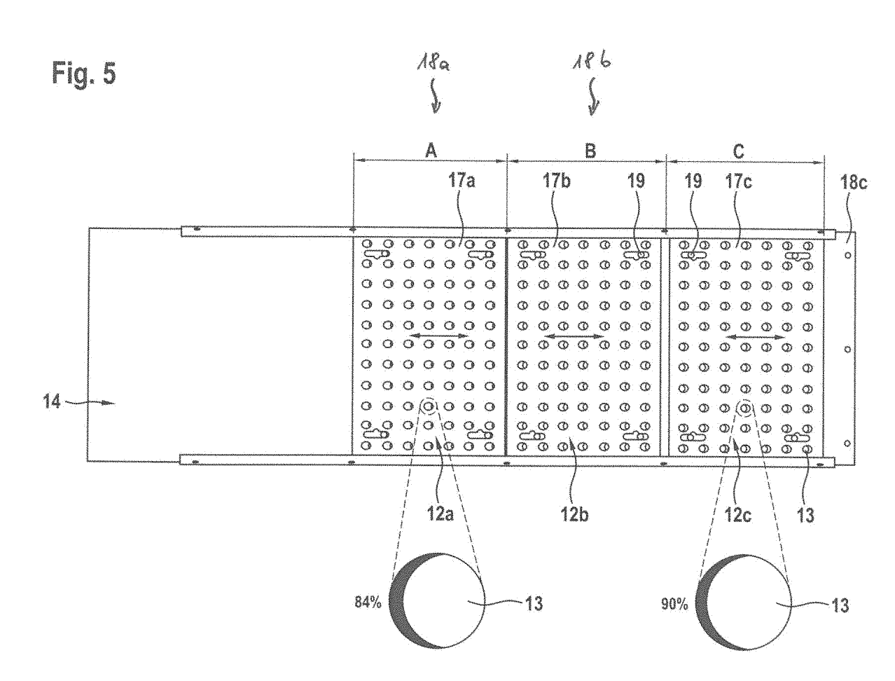

In the exemplary embodiment of FIG. 5, the partial areas of the air-guiding cylinder 18a, 18b, 18c and the metal sheets 17a, 17b, 17c for covering with the associated sections 12a, 12b, and 12c have the same width A=B=C. In this exemplary embodiment, also the openings 13 of all partial areas 18a, 18b, 18c of the air-guiding cylinder and the openings of the metal sheets 17a, 17b, 17c have the same size. It is apparent that the air or gas permeability of each partial area 18a, 18b, 18c of the air-guiding cylinder is separately adjustable along the longitudinal axis 6 of the air-guiding cylinder 10. In the partial area 18a, the openings are closed to 84% by means of the above disposed cover body (metal sheet 17a). The right partial area 18c with its openings 13 is opened to 90% by means of the above disposed cover body (metal sheet 17c). Thereby, the air or gas permeability of the air-guiding cylinder 10 is variable along the longitudinal axis 6 thereof.

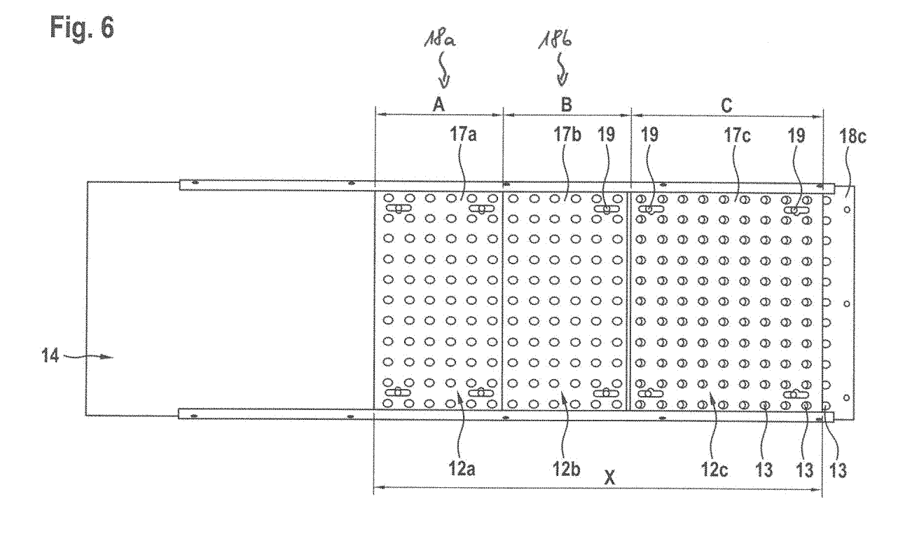

Based on FIG. 6, it is apparent that the free surface, namely the surface of the openings 13 with maximum through-flow, may amount from 8 to 30% of the surface of the partial areas 18a, 18b, 18c to be closed. Thereby, on the one hand, the velocity of the air flow 16 is affected, and on the other hand, the pressure level in the flow compartment 15. Both factors decisively have an influence on the uniformity of the air flow 16 in the flow compartment 15.

According to the invention, the air flow within the through-flow drum 5 may be harmonized in that the air or gas permeability of the air-guiding cylinder 10 is adjustable along the length as well as around the circumference thereof. The adjustability is achieved in that the air-guiding cylinder 10 has a plurality of openings 13, which, at least partially, may be opened or closed by means of at least one cover body, which is disposed within or at the air-guiding cylinder 10. The distribution of the plurality of openings 13 over individual sections 12a, 12b, etc. is particularly advantageous, which are separately closable along the longitudinal axis 6 and/or in circumferential direction of the air-guiding cylinder 10. In one embodiment, in which the air-guiding cylinder 10 is configured almost as a polygon having a plurality of flat surfaces, the air or gas permeability of the individual sections may be adjusted via displaceable perforated metal sheets, and may thereby achieve an optimal uniformity of the flow over the surface of the through-flow drum 5. Said adjustability is realized across the working width (punched or perforated width) of the through-flow drum or around the circumference. The number of sections across the working width and around the circumference depends on the size of the through-flow drum. In this case, the sections may be distributed regularly or irregularly over the surface of the air-guiding cylinder.

The Invention is intended for the use in particular in a drum dryer or thermobonder.

1. A device for thermally treating a continuous web of textile material, including:
at least one through-flow drum having a perforated envelope surface and adapted for having a continuous web of material looped at least partially around the envelope surface, wherein a heated gas is flowable through the continuous web of material and the envelope surface of the through-flow drum; and
an air-guiding cylinder disposed within the flow drum and having a plurality of openings, wherein the heated gas is withdrawable via an interior compartment thereof, wherein the air-guiding cylinder has an air or gas permeability that is adjustable around a circumference thereof.

2. The device according to claim 1, the air or gas permeability of the air-guiding cylinder is adjustable along a longitudinal axis thereof.

3. The device according to claim 1, including at least one cover body disposed at or within the air-guiding cylinder by which the openings of the air-guiding cylinder are at least partially closable.

4. The device according to claim 1, wherein the air-guiding cylinder has sections in which the air or gas permeability of each section is separately adjustable.

5. The device according to claim 4, wherein the sections are disposed along the a longitudinal axis of the air-guiding cylinder.

6. The device according to claim 4, wherein the air or gas permeability of each section is adjustable along at least one of a longitudinal axis thereof and around the circumference thereof.

7. The device according to claim 1, wherein the air-guiding cylinder comprises a cylindrical tube.

8. The device according to claim 1, wherein the air-guiding cylinder comprises a polygon having a plurality of flat surfaces.

9. The device according to claim 7, including at least one cover body disposed at or within the air-guiding cylinder by which the openings of the air-guiding cylinder are at least partially closable, the at least one cover body comprising one of a displaceable or rotatable cylinder, a rounded shell and a segment, to influence the air or gas permeability of the air-guiding cylinder.

10. The device according to claim 8, including at least one cover body disposed at or within the air-guiding cylinder by which the openings of the air-guiding cylinder are at least partially closable, wherein the at least one cover body is configured as a metal sheet which is disposed lengthwise or transversely adjustable to a longitudinal axis of the air-guiding cylinder.

11. The device according to claim 1, wherein the perforated surface of the through-flow drum is 8 to 20 times larger than an area of the openings of the air-guiding cylinder.

12. The device according to claim 1, wherein the diameter of the air-guiding cylinder amounts to 20% to 70% of the diameter of the through-flow drum.

13. A method for thermally treating a continuous web of textile material in a drum dryer or a thermobonder including at least one through-flow drum having a perforated envelope, with a continuous web of material looping at least partially around the envelope thereof, the method including:
flowing a heated gas through the continuous web of material and the envelope of the through-flow drum
disposing an air-guiding cylinder within the through-flow drum;
withdrawing the heated gas via an interior compartment of the air-guiding cylinder, wherein a flow compartment is disposed between the air-guiding cylinder and the through-flow drum; and
modifying the flow conditions of the heated gas by adjusting the air or gas permeability of the air-guiding cylinder.

14. The method according to claim 13, including adjusting the air or gas permeability of the air-guiding cylinder along a longitudinal axis thereof.

15. The method according to claim 13, wherein the air-guiding cylinder has sections and the adjusting includes adjusting the air or gas permeability of the sections.

16. The method according to claim 15, wherein the adjusting includes adjusting the air or gas permeability separately for each section and independently from the other sections.

17. (canceled)
